(19) United States
(12) Patent Application Publication
(10) Pub. No.: US 2026/0107868 A1
(43) Pub. Date: Apr. 23, 2026

(54) OPTIMAL CONFIGURATION METHOD OF ENGINEERING, BIOLOGY AND FARMING COMPREHENSIVE MEASURES FOR SOIL AND WATER CONSERVATION IN ECOLOGICALLY FRAGILE REGION

(71) Applicant: Yellow River Institute of Hydraulic Research, YRCC, Zhengzhou (CN)

(72) Inventors: Peiqing Xiao, Zhengzhou (CN); Zhenzhou Shen, Zhengzhou (CN); Pan Zhang, Zhengzhou (CN); Peng Jiao, Zhengzhou (CN); Houjun He, Zhengzhou (CN); Pengcheng Sun, Zhengzhou (CN); Jingshu Wang, Zhengzhou (CN); Wenmin Zhang, Zhengzhou (CN); Feng Feng, Zhengzhou (CN); Yang Liu, Zhengzhou (CN); Yufei Zhang, Zhengzhou (CN); Chunjing Zhao, Zhengzhou (CN); Jihang Li, Zhengzhou (CN)

(21) Appl. No.: 18/979,528

(22) Filed: Dec. 12, 2024

(30) Foreign Application Priority Data
Oct. 22, 2024 (CN) 202411475700.6

(51) Int. Cl. A01B 79/00

(52) U.S. Cl. CPC A01B 79/005

(57) ABSTRACT

An optimal configuration method of engineering, biological and farming comprehensive measures for soil and water conservation in an ecologically fragile region includes: a, regional division and evaluation: according to the topography, soil, climate and hydrological conditions of the ecologically fragile region, the region is divided into different functional regions, including a slope top region, a slope middle region, a slope toe region, and a ditch region according to different slope gradients. The soil and water conservation capacity of the ecologically fragile region is significantly improved through the comprehensive application of engineering, biology and farming measures. Through accurate regional division and evaluation, differentiated engineering facility planning and vegetation selection are adopted for the regions of different slope gradients, which can effectively reduce water and soil loss, and facilities are maintained for a long time by using an intelligent monitoring system, thereby solving the adverse effects of climate change and external environment.

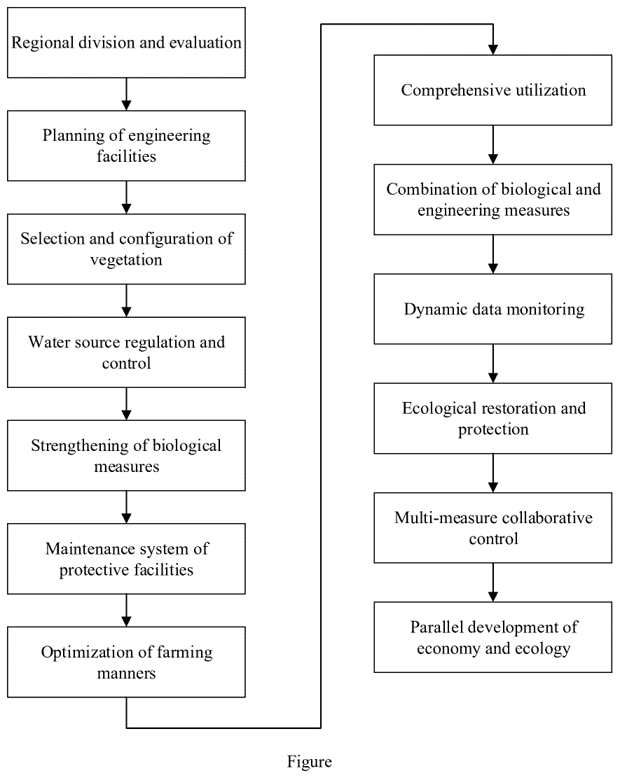

### TECHNICAL FIELD

The disclosure relates to the technical field of soil and water conservation, in particular to an optimal configuration method of engineering, biology and farming comprehensive measures for soil and water conservation in an ecologically fragile region.

### BACKGROUND

Soil and water conservation in ecologically fragile regions needs comprehensive optimal configuration by combining three aspects of engineering, biological and farming measures, with the purpose of reducing water and soil loss, restoring ecological environment and enhancing the economic value of lands. First of all, according to the principle of adjusting measures to local conditions, appropriate engineering measures, such as building terraces, warping dams and ditch protection, are selected to ensure the basic role of slope surface soil and water conservation. Secondly, the biological measures include planting plants with strong corrosion resistance, such as combining forest and grass, to form coverage vegetation and prevent water from eroding the earth surface. Finally, the farming measures are optimized in land use, and the crop planting and breeding mode adapted to local environment is promoted to achieve a win-win situation for economy and ecology.

Defects of the system are mainly manifested in the following aspects: the process of ecological restoration in the region is possibly affected by external environment such as climate change, especially, the situations of drought and insufficient precipitation will limit the effect of vegetation restoration. In long-term operation, the engineering measures are prone to the problem of insufficient maintenance, leading to the weakening of engineering effects, especially, the risk of sediment accumulation and dam failure of warping dams and other facilities needs continuous monitoring.

### SUMMARY

Aiming at the shortcomings of the related art, the disclosure provides an optimal configuration method of engineering, biological and farming comprehensive measures for soil and water conservation in ecologically fragile regions, which solves the problem of influence by external environment such as climate change and the problem of weakening of engineering effects caused by easily caused insufficient maintenance in long-term operation.

In order to achieve the above objective, the disclosure is realized by the following technical solution. Specifically, an optimal configuration method of engineering, biology and farming comprehensive measures for soil and water conservation in ecologically fragile regions includes the following steps.

Step a, regional division and evaluation: according to the topography, soil, climate and hydrological conditions of the ecologically fragile region, the ecologically fragile region is divided into different functional regions, including a slope top region, a slope middle region, a slope toe region, a ditch region and other regions. According to different slope gradients, the slope top region with a slope gradient of greater than 25° needs priority for engineering protection, the slope middle region with a slope gradient of 15°-25° is suitable for biological measures of combining forest and grass, and the slope toe region with a slope gradient of less than 15° is suitable for terrace construction.

Step b, planning of engineering facilities: water and soil conservation projects are planned and constructed in a slope surface and the ditch region, including a terrace, a warping dam, an intercepting ditch and other protective facilities. The terrace is provided with a drainage outlet every 50 meters, and a silt interception capacity of the warping dam is 10,000 tons per square kilometer per year, so as to ensure a protection capacity of water and soil loss.

Step c, selection and configuration of vegetation: according to the local annual average precipitation of about 300 millimeters and soil water content of about 10%, local plants with drought resistance and wind erosion resistance for planting are selected, including Caragana arborescens, Hippophae rhamnoides and Pinus tabulaeformis. The macrophanerophytes, shrubs and herbs are planted in the slope top region and the slope middle region to form a composite ecological forest network structure.

Step d, water source regulation and control: a water source conservation system is designed, natural precipitation and artificial regulation and storage are combined, small impounding reservoirs and cellars are used, and each cellar has a capacity of 100 cubic meters, to ensure that water can be provided for vegetation in dry season.

Step e, strengthening of biological measures: biological interception facilities are promoted in slope surface restoration and a shelterbelt, in which a target of vegetation coverage is 85%, the vegetation can reduce the runoff by 60%, and anti-corrosion and soil and water conservation functions of the vegetation are strengthened by means of combining the herbs, the shrubs and the macrophanerophytes.

Step f, maintenance system of the protective facilities: a long-term maintenance system of engineering facilities is designed, including intelligent monitoring sensors and automatic cleaning devices. The intelligent monitoring sensors detect silt accumulation of the terrace and the warping dam, the silt is cleaned twice every year, and a cleaning amount of the silt is about 5,000 cubic meters each time.

Step g, optimization of farming manners: highly adaptable farming manners are introduced, dry farming in a soil and water conservation project region is promoted. The drought-tolerant crops, such as buckwheat, soybean and mung bean, are mainly planted and an irrigation water demand is reduced by 20%.

Step h, comprehensive utilization: biological and engineering measures are combined to promote high-efficiency agriculture in the ditch region and the slope toe region. A planting area of economic forest network reaches 20 apricot trees per hectare, grass plants are planted therebetween, and about 600 kg/hectare of apricot fruits are produced every year, with an income increase of 6,000 yuan/hectare.

Step i, dynamic data monitoring: a real-time dynamic monitoring system is constructed for key environmental factors such as climate, precipitation and soil water content. The soil water content is updated once every quarter, and the dynamic data monitoring shows that the water content reaches a peak of 30% in precipitation season and drops to a minimum of 5% in dry season.

Step j, ecological restoration and protection: the measures of closing hillsides to facilitate afforestation and returning farmlands to forests are adopted, with the target of increasing the vegetation coverage to 70% and reducing soil erosion by 80% in the next three years.

Step k, multi-measure collaborative control: the engineering measures and biological measures are combined for use. A runoff interception rate of the vegetation is 60%, and the engineering measures such as the terrace and the warping dam can reduce the runoff and silt output by 40%.

Step l, parallel development of economy and ecology: optimal configuration is performed on planting structures and industrial models, with the target of increasing land income by 15% every year during ecological restoration and providing 30% employment opportunities for local residents.

In an embodiment, in the regional division, shelterbelt planting is given priority to the slope top region with the slope gradient greater than 25°, water intercepting ditches are installed in cooperation, and the soil loss is reduced by 30% every year.

In an embodiment, the warping dam is made of water-resistant and durable materials, the local plants with drought resistance and wind resistance of the Caragana arborescens, the Hippophae rhamnoides and the Pinus tabulaeformis have priority for vegetation configuration, and the vegetation coverage needs to reach over 80%.

In an embodiment, mixed planting of the macrophanerophytes, the shrubs and the herbs is adopted in vegetation selection and configuration, and soil stability and water conservation are enhanced by selecting plants with different root depths.

In an embodiment, a rainwater collection system with natural water catchment through the slope surface and a ditch interception technology are used for the water source regulation and control, and rainwater collection can reach 30% of annual precipitation

In an embodiment, the farming manners are adjusted according to seasonal rainfall changes, and crop rotation is adopted to ensure sustainable use of lands and keep a soil fertility above 15%.

In an embodiment, the dynamic data monitoring collects the climate, the soil water content and precipitation data in real time through a sensor network deployed in the ecologically fragile region, and provides decision support for irrigation and vegetation management.

In an embodiment, a water source regulation and control system is equipped with small impounding reservoirs, and each impounding reservoir has a capacity of 100 cubic meters and is used for ensuring water supply of the vegetation in dry season.

The disclosure provides the optimal configuration method of engineering, biological and farming comprehensive measures for soil and water conservation in the ecologically fragile region, and has the following beneficial effects.

According to the optimal configuration method of engineering, biological and farming comprehensive measures for soil and water conservation in the ecologically fragile region, the soil and water conservation capacity of the ecologically fragile region is significantly improved by comprehensively applying the engineering measures, biological measures and farming measures. Through accurate regional division and evaluation, differentiated engineering facility planning and vegetation selection are adopted for the regions of different slope gradients, which can effectively reduce the water and soil loss, and facilities are maintained for a long time by using an intelligent monitoring system, thereby solving the adverse effects of climate change and external environment. The innovative water source regulation and control system combines rainwater collection with small reservoirs to ensure the water demand of vegetation in dry season and greatly improve the vegetation coverage and ecological stability.

The disclosure achieves better balance between economic benefits and ecological protection, and promotes the economic forests and drought-tolerant crops adapted to local climate conditions by comprehensively utilizing the biological measures and efficient agricultural planting modes, thus effectively improving land utilization efficiency and creating more employment opportunities. The introduction of a dynamic data monitoring system ensures the accuracy of agricultural cultivation and vegetation management, optimizes the configuration of resources, and ensures the sustainable development of lands and the long-term economic income increase of local residents.

### BRIEF DESCRIPTION OF DRAWING

Figure is a schematic flowchart of the disclosure.

### DETAILED DESCRIPTION OF EMBODIMENTS

In the following, the technical solution in the embodiments of the disclosure will be clearly and completely described in combination with the accompanying drawings in the embodiments of the disclosure. Apparently, the described embodiments are only part but not all of the embodiments of the disclosure. Based on the embodiments in the disclosure, all other embodiments obtained by those ordinary skilled in the art without creative labor belong to the scope of protection of the disclosure.

As shown in the figure, an optimal configuration method of engineering, biology and farming comprehensive measures for soil and water conservation in an ecologically fragile region according to the embodiment of the disclosure includes the following steps. Step a, regional division and evaluation: according to the topography, soil, climate and hydrological conditions of the ecologically fragile region, the ecologically fragile region is divided into different functional regions, including a slope top region, a slope middle region, a slope toe region, a ditch region and other regions. According to different slope gradients, the slope top region with a slope gradient of greater than 25° needs priority for engineering protection, the slope middle region with a slope gradient of 15°-25° is suitable for biological measures of combining forest and grass, the slope toe region with a slope gradient of less than 15° is suitable for terrace construction. In the regional division, shelterbelt planting is given priority to the slope top region with the slope gradient greater 25°, water intercepting ditches are installed in cooperation, and the soil loss is reduced by 30% every year.

Step b, planning of engineering facilities: water and soil conservation projects, including a terraces, a warping dam, an intercepting ditch and other protective facilities, are planned and constructed in a slope surface and the ditch region, the terrace is provided with a drainage outlet every 50 meters, a silt interception capacity of the warping dam is 10,000 tons per square kilometer per year, so as to ensure a protection capacity of water and soil loss, the warping dam is made of water-resistant and durable materials, the local plant with drought resistance and wind erosion resistance Caragana arborescens, Hippophae rhamnoides and Pinus tabulaeformis are used for vegetation configuration, and the vegetation coverage needs to reach over 80%.

Step c, selection and configuration of vegetation: according to the local annual average precipitation of about 300 millimeters and soil water content of about 10%, local plants with drought resistance and wind erosion resistance, such as Caragana arborescens, Hippophae rhamnoides and Pinus tabulaeformis, are selected for planting. Macrophanerophytes, shrubs and herbs are planted in the slope top region and the slope middle region to form a composite ecological forest network structure, mixed planting of the macrophanerophytes, the shrubs and the herbs is adopted in vegetation selection and configuration, and soil stability and water conservation are enhanced by selecting plants with different root depths.

Step d, water source regulation and control: a water source conservation system is designed, natural precipitation and artificial regulation and storage are combined, small impounding reservoirs and cellars are used, each cellar has a capacity of 100 cubic meters, to ensure that water can be provided for vegetation in dry season, a rainwater collection system with natural water catchment through the slope surface and a ditch interception technology are used for the water source regulation and control, and rainwater collection can reach 30% of annual precipitation.

Step e, strengthening of biological measures: biological interception facilities are prompted in slope surface restoration and a shelterbelt, a target of vegetation coverage is 85%, the vegetation can reduce the runoff by 60%, and anti-corrosion and soil and water conservation functions of the vegetation are strengthened by means of combining the herbs, the shrubs and the macrophanerophytes.

Step f, maintenance system of protective facilities: a long-term maintenance system of engineering facilities, including intelligent monitoring sensors and automatic cleaning devices, is designed, the intelligent monitoring sensors detect silt accumulation of the terraces and warping dams, the silt is cleaned twice every year, and a cleaning amount of the silt is about 5,000 cubic meters each time.

Step g, optimization of farming methods: highly adaptable farming manners are introduced, dry farming is promoted in a soil and water conservation project region, drought-tolerant crops, such as buckwheat, soybean and mung bean, are mainly planted, an irrigation water demand is reduced by 20%, the farming manners are adjusted according to seasonal rainfall changes, and a rotation system is adopted to ensure sustainable use of lands and keep a soil fertility above 15%.

Step h, comprehensive utilization: biological and engineering measures are combined to promote high-efficiency agriculture in the ditch region and the slope toe region, a planting area of economic forest network reaches 20 apricot trees per hectare, grass plants are planted therebetween, and about 600 kg/hectare of apricot fruits are produced every year, with an income increase of 6,000 yuan/hectare.

Step i, dynamic data monitoring: a real-time dynamic monitoring system for key environmental factors such as climate, precipitation and soil water content is constructed, the soil water content is updated once every quarter, the monitoring shows that the water content reaches a peak of 30% in precipitation season and drops to a minimum of 5% in dry season, and the dynamic data monitoring collects climate, soil water content and precipitation data in real time through a sensor network deployed in the ecologically fragile region, and provides decision support for irrigation and vegetation management.

Step j, ecological restoration and protection: thee measures of closing hillsides to facilitate afforestation and returning farmlands to forests are adopted, with the target of increasing the vegetation coverage to 70% and reducing soil erosion by 80% in the next three years, a water source regulation and control system is equipped with small impounding reservoirs, and each impounding reservoir has a capacity of 100 cubic meters and is used for ensuring water supply of the vegetation in dry season.

Step k, multi-measure collaborative control: the engineering measures and biological measures are combined for use, a runoff interception rate of the vegetation is 60%, and the engineering measures such as terrace and the warping dam can reduce the runoff and silt output by 40%.

Step l, parallel development of economy and ecology: optimal configuration is performed on planting structures and industrial models, with the target of increasing land income by 15% every year during ecological restoration and providing 30% employment opportunities for local residents.

Although the embodiments of the disclosure have been shown and described, it can be understood by those ordinary skilled in the art that various changes, modifications, substitutions and transformations can be made to these embodiments without departing from the principles and spirit of the disclosure, and the scope of the disclosure is defined by the appended claims and their equivalents.

What is claimed is:

1. An optimal configuration method of engineering, biology and farming comprehensive measures for soil and water conservation in an ecologically fragile region, comprising:
step a, regional division and evaluation: dividing the ecologically fragile region into different functional regions comprising a slope top region, a slope middle region, a slope toe region, a ditch region according to topography, soil, climate and hydrological conditions of the ecologically fragile region; based on different slope gradients, performing priority engineering protection on the slope top region with a slope gradient of greater than 25°, performing biological measures of combining forest and grass on the slope middle region with a slope gradient of 15°-25°, and performing terrace construction on the slope toe region with a slope gradient of less than 15°;
step b, planning of engineering facilities: planning and constructing water and soil conservation projects in a slope surface and the ditch region, comprising protective facilities of a terrace, a warping dam, and an intercepting ditch, wherein the terrace is provided with a drainage outlet every 50 meters, and a silt interception capacity of the warping dam is 10,000 tons per square kilometer per year, so as to ensure a protection capacity of water and soil loss;
step c, selection and configuration of vegetation: selecting local plants with drought resistance and wind erosion resistance for planting according to local annual average precipitation of about 300 millimeters and soil water content of about 10%, wherein the local plants comprise Caragana arborescens, Hippophae rhamnoides and Pinus tabulaeformis; and planting macrophanerophytes, shrubs and herbs in the slope top region and the slope middle region to form a composite ecological forest network structure;
step d, water source regulation and control: designing a water source conservation system, combining natural precipitation and artificial regulation and storage, and using impounding reservoirs and cellars, wherein each cellar has a capacity of 100 cubic meters, to ensure that water can be provided for vegetation in dry season;
step e, strengthening of biological measures: promoting biological interception facilities in slope surface restoration and a shelterbelt, wherein a target of vegetation coverage is 85%, runoff of 60% is reduced by the vegetation, and anti-corrosion and soil and water conservation functions of the vegetation are strengthened by means of combining the herbs, the shrubs and the macrophanerophytes;
step f, maintenance system of the protective facilities: designing a long-term maintenance system of engineering facilities, comprising intelligent monitoring sensors and automatic cleaning devices, wherein the intelligent monitoring sensors are configured to detect silt accumulation of the terrace and the warping dam, the silt is cleaned twice every year, and a cleaning amount of the silt is about 5,000 cubic meters each time;
step g, optimization of farming manners: introducing adaptable farming manners, promoting dry farming in a soil and water conservation project region, and planting drought-tolerant crops in the soil and water conservation project region; wherein the drought-tolerant crops comprise buckwheat, soybean and mung bean, and an irrigation water demand is reduced by 20%;
step h, comprehensive utilization: combining biological and engineering measures to promote agriculture in the ditch region and the slope toe region, wherein a planting area of economic forest network reaches 20 apricot trees per hectare, grass plants are planted therebetween, and about 600 kg/hectare of apricot fruits are produced every year, with an income increase of 6,000 yuan/hectare;
step i, dynamic data monitoring: constructing a real-time dynamic monitoring system for key environmental factors comprising: climate, precipitation and soil water content, wherein the soil water content is updated once every quarter, and the dynamic data monitoring shows that the soil water content reaches a peak of 30% in precipitation season and drops to a minimum of 5% in dry season;
step j, ecological restoration and protection: closing hillsides to facilitate afforestation and returning farmlands to forests, with a target of increasing the vegetation coverage to 70% and reducing soil erosion by 80% in next three years;
step k, multi-measure collaborative control: combining the engineering measures and the biological measures for use, wherein a runoff interception rate of the vegetation is 60%, and the engineering measures comprising the terrace and the warping dam reduce the runoff and silt output by 40%; and
step l, parallel development of economy and ecology: performing optimal configuration on planting structures and industrial models, with another target of increasing land income by 15% every year during ecological restoration and providing 30% employment opportunities for local residents.

2. The optimal configuration method of engineering, biology and farming comprehensive measures for soil and water conservation in the ecologically fragile region according to claim 1, wherein in the regional division, shelterbelt planting is given priority to the slope top region with the slope gradient greater than 25°, and water intercepting ditches are installed in cooperation.

3. The optimal configuration method of engineering, biology and farming comprehensive measures for soil and water conservation in the ecologically fragile region according to claim 1, wherein the warping dam is made of water-resistant and durable materials, the local plants with drought resistance and wind erosion resistance of the Caragana arborescens, the Hippophae rhamnoides and the Pinus tabulaeformis have priority for vegetation configuration, and the vegetation coverage needs to reach over 80%.

4. The optimal configuration method of engineering, biology and farming comprehensive measures for soil and water conservation in the ecologically fragile region according to claim 1, wherein mixed planting of the macrophanerophytes, the shrubs and the herbs is adopted in vegetation selection and configuration, and soil stability and water conservation are enhanced by selecting plants with different root depths.

5. The optimal configuration method of engineering, biology and farming comprehensive measures for soil and water conservation in the ecologically fragile region according to claim 1, wherein a rainwater collection system with natural water catchment through the slope surface and a ditch interception technology are used for the water source regulation and control.

6. The optimal configuration method of engineering, biology and farming comprehensive measures for soil and water conservation in the ecologically fragile region according to claim 1, wherein the farming manners are adjusted according to seasonal rainfall changes, and crop rotation is adopted to ensure sustainable use of lands and keep a soil fertility above 15%.

7. The optimal configuration method of engineering, biology and farming comprehensive measures for soil and water conservation in the ecologically fragile region according to claim 1, wherein the dynamic data monitoring collects the climate, the soil water content and precipitation data in real time through a sensor network deployed in the ecologically fragile region, and provides decision support for irrigation and vegetation management.

8. The optimal configuration method of engineering, biology and farming comprehensive measures for soil and water conservation in the ecologically fragile region according to claim 1, wherein in the water source regulation and control, the impounding reservoirs are equipped, and each impounding reservoir has a capacity of 100 cubic meters and is used for ensuring water supply of the vegetation in dry season.
